(19) United States
(12) Patent Application Publication
(10) Pub. No.: US 2003/0177611 A1
(43) Pub. Date: Sep. 25, 2003

(54) Combination of handle with cover

(76) Inventor: Ching-Hui Lin, Taichung Hsien (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/383,667

(22) Filed: Mar. 7, 2003

(30) Foreign Application Priority Data
Mar. 20, 2002 (TW) 91203533

(51) Int. Cl. B62B 1/00

(52) U.S. Cl. 16/430

(57) ABSTRACT

According to the present invention, a handle-cover combination includes a handle and a cover. The handle defines at least one hole. The cover includes at least one fastener formed thereon. The at least one fastener is inserted in the at least one hole. The cover may include a hard layer on which the fastener is formed and a soft layer secured to the hard layer.

### BACKGROUND OF INVENTION

1. Field of Invention

The present invention relates to a combination of a handle with a cover.

2. Related Prior Art

Referring to FIG. 9, a conventional nail stapler 1 includes a handle 2 and a cover 3 mounted on the handle 2. The cover 3 is made larger than the handle 2. After the cover 3 is mounted on the handle 2, the cover 3 is heated so as to shrink and wrap the handle 2. However, the cover 3 tends to slip on the handle 2. Furthermore, the cover 3 cannot adequately cushion vibration resulting from use of the nail stapler 1 since the cover 3 becomes thin and hard after it is heated.

The present invention is therefore intended to obviate or at least alleviate the problems encountered in prior art.

### SUMMARY OF INVENTION

It is an objective of the present invention to provide a non-slippery cover for a handle.

It is another objective of the present invention to provide a handle with a cover for adequately cushioning vibration.

According to the present invention, a handle-cover combination includes a handle and a cover. The handle defines at least one hole. The cover includes at least one fastener formed thereon. The at least one fastener is inserted in the at least one hole.

The cover may include a hard layer on which the fastener is formed and a soft layer secured to the hard layer.

Other objects, advantages, and novel features of the invention will become more apparent from the following detailed description when taken in conjunction with the attached drawings.

### BRIEF DESCRIPTION OF DRAWINGS

The present invention will be described through detailed illustration of embodiments referring to the attached drawings wherein:

FIG. 1 is a side view of a tool including a combination of a handle with two covers according to a first embodiment of the present invention.

FIG. 2 is an exploded view of the combination shown in FIG. 1.

FIG. 3 is similar to FIG. 1 but showing the covers disengaged from the handle in a partially cross-sectional view.

FIG. 4 is similar to FIG. 3 but showing the covers engaged with the handle.

FIG. 5 is a cross-sectional view taken along a line 5-5 in FIG. 4.

FIG. 6 is similar to FIG. 5 but showing a handle-cover combination according to a second embodiment of the present invention.

FIG. 7 is a cross-sectional view of a handle-cover combination according to a third embodiment of the present invention.

FIG. 8 is a cross-sectional view of a handle-cover combination according to a fourth embodiment of the present invention.

FIG. 9 is a side view of a tool with a conventional handle and a conventional cover.

### DETAILED DESCRIPTION OF PREFERRED EMBODIMENT

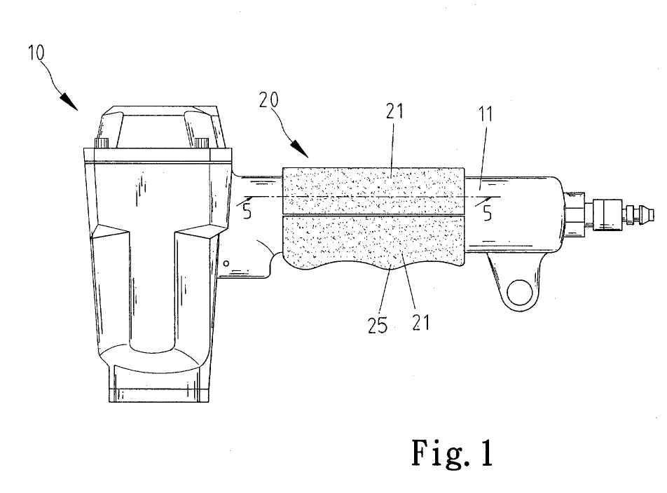

FIG. 1 shows a tool 10 with a handle-cover combination 20 according to a first embodiment of the present invention.

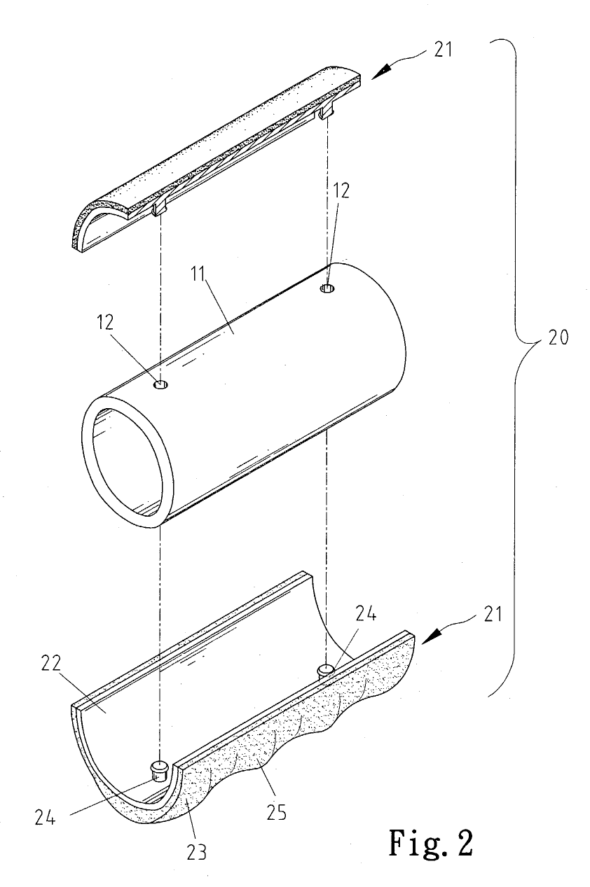

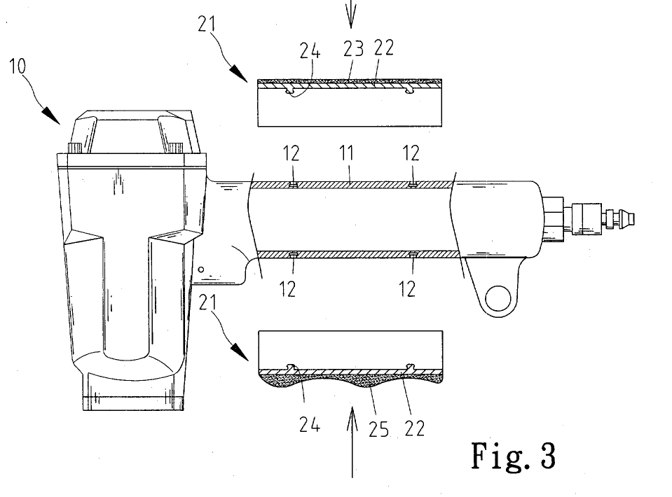

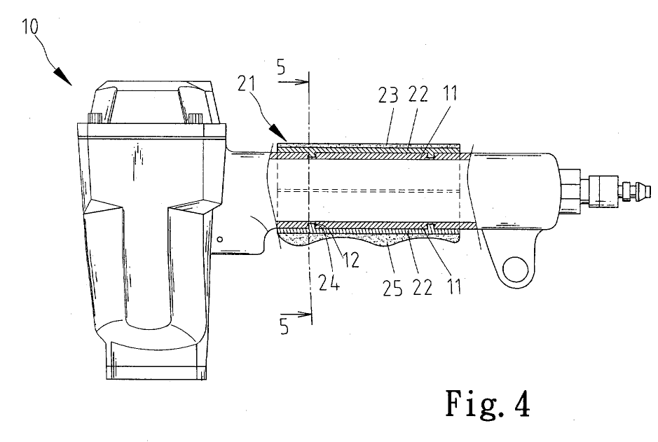

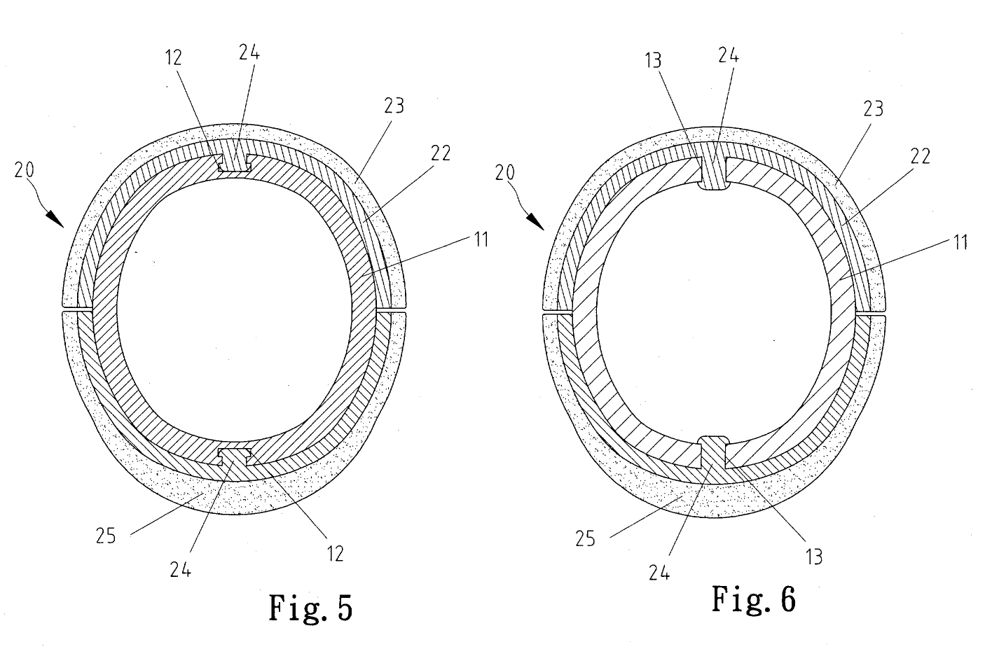

Referring to FIGS. 2-5, the handle-cover combination 20 includes a handle 11 and two covers 21.

The handle 11 is a tubular element with an external face and an internal face. The handle 11 defines four holes 12. Each of the holes 12 includes a small portion and a large portion, thus forming an annular shoulder between them.

Each of the covers 21 includes a hard layer 22 for engagement with the handle 11 and a soft layer 23 for contact with a user's hand. The hard layer 22 provides adequate rigidity for each of the covers 21. The hard layer 22 includes a first face and a second face. Two fasteners 24 are formed on the first face of hard layer 22. Each of the fasteners 24 includes a small portion and a large portion, thus forming an annular shoulder between them. Each of the fasteners 24 is inserted in one of the holes 12 so that its large portion is fit in the large portion of one of the holes 12. The annular shoulder of each of the fasteners 24 is engaged with the annular shoulder of one of the holes 12. The soft layer 23 provides a nice touch for the user's hand. The soft layer 23 includes a first face adhered to the hard layer 22 and a second face for contact with the user's hand. The soft layer 23 of one of the covers 21 is formed with a plurality of ribs 25.

FIG. 6 shows a handle-cover combination according to a second embodiment of the present invention. The second embodiment differs from the first embodiment in that the handle 11 defines four holes 13 instead of the holes 12. The holes 13 extend from the external face to the internal face of the handle 11 and include no annular shoulder. Accordingly, the annular shoulder of each of the fasteners 24 is engaged with the internal face of the handle 11. Furthermore, the small portion of each of the fasteners 24 is longer in the second embodiment than the first embodiment.

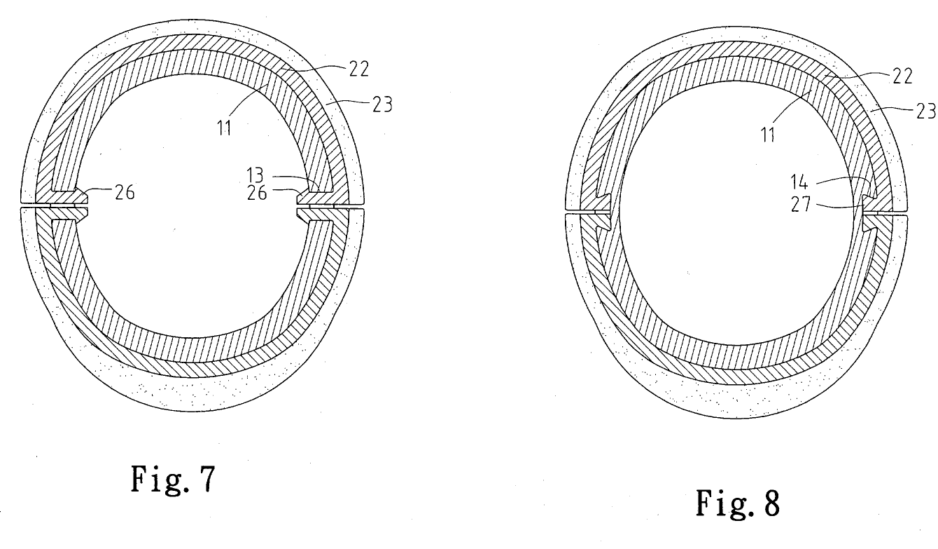

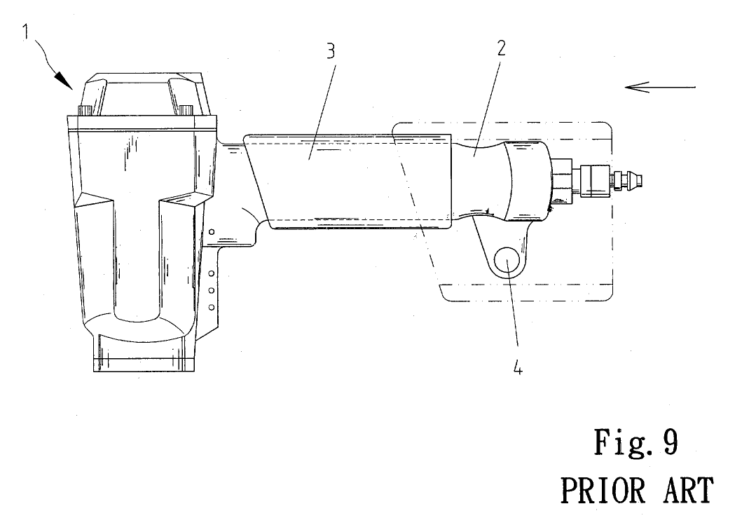

FIG. 7 shows a handle-cover combination according to a third embodiment of the present invention. The third embodiment differs from the second embodiment in that each of the covers 21 includes four fasteners 26 (only two are shown). Regarding each of the covers 21, two (only one is shown) of the fasteners 26 are positioned along an edge of the cover 21 and the others of the fasteners 26 are positioned in another edge of the cover 21. Each of the fasteners 26 of one of the covers 21 and one of the fasteners 26 of the other of the covers 21 form a configuration similar to that of the fasteners 24.

FIG. 8 shows a handle-cover combination according to a fourth embodiment of the present invention. The fourth embodiment differs from the third embodiment in that the holes 12 become larger in a direction from the external face to the internal face of the handle 11. Accordingly, the fasteners 27 are configured in compliance with the holes 14.

The present invention has been described through detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A handle-cover combination including:
a handle defining at least one hole; and
a cover including at least one fastener formed thereon and inserted into the at least one hole.

2. The handle-cover combination according to claim 1 wherein the fastener includes an enlarged portion.

3. The handle-cover combination according to claim 2 wherein the hole has an enlarged portion for receiving the enlarged portion of the fastener.

4. The handle-cover combination according to claim 2 wherein the handle is a tubular element with an external face and an internal face against which the enlarged portion of the fastener is located.

5. The handle-cover combination according to claim 1 wherein the hole gets larger as it extends into the handle and the fastener is configured in compliance with the hole.

6. The handle-cover combination according to claim 1 wherein the cover includes a hard layer on which the fastener is formed and a soft layer secured to the hard layer.

7. A handle-cover combination including:
a handle defining at least two hole; and
two covers each including at least one fastener fit in the holes.

8. The handle-cover combination according to claim 7 wherein the fastener of each of the covers includes an enlarged portion.

9. The handle-cover combination according to claim 8 wherein each of the holes includes an enlarged portion for receiving the enlarged portion of the fastener of each of the covers.

10. The handle-cover combination according to claim 8 wherein the handle is a tubular element with an external face and an internal face against which the enlarged portion of the fasteners of each of the covers is located.

11. The handle-cover combination according to claim 7 wherein the holes get larger as they extend into the handle and the fasteners are configured in compliance with the holes.

12. The handle-cover combination according to claim 7 wherein each of the covers includes a hard layer on which the fastener is formed and a soft layer adhered to the hard layer.

13. The handle-cover combination according to claim 7 wherein each of the covers includes two fasteners each formed at an edge thereof.

14. The handle-cover combination according to claim 13 wherein each of the fasteners of one of the covers and one of the fasteners of the remaining one of the covers are inserted in one of the holes.

15. The handle-cover combination according to claim 14 wherein the handle is a tubular element with an external face and an internal face, and the hole extends from the external face to the internal face of the handle.

16. The handle-cover combination according to claim 15 wherein each of the fasteners includes an enlarged portion located against the internal face of the handle.

17. The handle-cover combination according to claim 15 wherein each of the fasteners of each of the covers and one of the fasteners of the remaining one of the covers together make a mushroom-shaped shape.

18. The handle-cover combination according to claim 14 wherein each of the holes includes an enlarged portion and each of the fasteners includes an enlarged portion fit in the enlarged portion of each of the holes.

19. The handle-cover combination according to claim 14 wherein each of the holes includes an enlarged portion and each of the fasteners of each of the covers and one of the fasteners of the remaining one of the covers together make a mushroom-shaped shape.

20. The handle-cover combination according to claim 14 wherein the holes get larger as they extend into the handle and the fasteners are configured in compliance with the holes.
